(19) United States
(12) Patent Application Publication
(10) Pub. No.: US 2006/0057028 A1
(43) Pub. Date: Mar. 16, 2006

(54) Biochip production apparatus

(75) Inventors: Takeo Tanaami, Tokyo (JP); Saya Satou, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION

(21) Appl. No.: 11/221,937

(22) Filed: Sep. 9, 2005

(30) Foreign Application Priority Data
Sep. 10, 2004 (JP) P.2004-263727

(51) Int. Cl. B01L 3/00

(52) U.S. Cl. 422/99; 422/100; 422/130

(57) ABSTRACT

A biochip production apparatus for arranging a plurality of different biopolymers on a substrate of a biochip, has a support body which enables to move in any directions, a stamp to be attached to the support body, and a biopolymer solution supply unit which supplies plural kinds of biopolymer solutions to be fixed on a surface of the stamp. The biopolymer solution supply unit fixes the biopolymer solutions on the surface of the stamp, and the stamp to which the biopolymer solutions is fixed is pressed against the surface of the substrate to thereby fix the biopolymer solutions on the surface of the biochip substrate in the same arrangement as in the stamp to form a plurality of sites simultaneously.

### CROSS-REFERENCE TO RELATED APPLICATIONS

This application is based upon and claims the benefit of priority from the prior Japanese Patent Applications No. 2004-263727, filed on Sep. 10, 2004, the entire contents of which are incorporated herein by reference.

### BACKGROUND OF THE INVENTION

1. Field of the Invention

The present invention relates to a biochip production apparatus for producing a biochip.

2. Description of the Related Art

A biochip in which biopolymers such as DNA, protein, etc. are fixed at high density has appeared. For example, this type biochip is formed so that tens to tense of thousands kinds to hundreds of different kinds of biopolymers are arranged on a substrate.

JP-A-2002-243736 is referred to as a related art of a method of producing a biochip by arranging biopolymers on a substrate.

FIG. 10 shows a dispensing device for achieving the biochip producing method described in JP-A-2002-243736. The dispensing device 1 includes a reagent dispenser 2 having an elongate open capillary channel 4. The capillary channel 4 is made from a pair of long and narrow members 2a and 2b. The members 2a and 2b approach each other so that the capillary channel 4 is tapered off to a tip of a lower end of the channel 4, that is, to a tip region 3 of the channel 4. A certain amount of a reagent solution 5 is held in the tip region 3.

The reagent dispenser 2 is connected to a connection member 8 so that the reagent dispenser 2 can also move up and down in accordance with the up/down motion of a solenoid piston 7 of a solenoid 6. The solenoid 6 is connected to an arm 9 so that the dispensing device 1 as a whole can be moved up, down, left and right to a predetermined position suitably by the arm 9.

According to the dispensing device, when the reagent dispenser 2 is moved close to or away from a support surface (not shown) rapidly by the solenoid piston 7 after the dispensing device 1 is moved left and right, that is, to a predetermined position in a plane (X-Y plane) perpendicular to the paper surface of FIG. 10 and moved to a suitable up-down position, a solution reserved in the front end region 3 of the dispensing device 1 can be spotted on a support body (e.g. biochip) put on the support surface.

The above reagent dispenser however has the following problems.

(1) It takes a long time to fill the reagent dispenser 2 with a new reagent solution because it is necessary to perform the steps of: immersing the reagent dispenser 2 in a cleaning fluid; removing the cleaning fluid sucked into the capillary channel 4; and immersing the capillary channel 4 in a new reagent solution.

(2) Different kinds of reagent solutions are contaminated because one reagent dispenser 2 is used for spotting the different kinds of reagent solutions.

(3) In the spotting by the reagent dispenser 2, it is difficult to obtain a uniform distribution of sites because it is not easy to fix a constant amount of reagent on the support surface (surface of the biochip substrate) at all times.

### SUMMARY OF THE INVENTION

An object of the invention is to provide a biochip production apparatus in which the time required for producing a biochip can be shortened, solutions of different kinds of biopolymers (referred to as biopolymer solutions) can be prevented from being contaminated, and uniform sites can be obtained easily.

The invention provides a biochip production apparatus for arranging a plurality of different biopolymers on a substrate of a biochip, having: a support body which enables to move in any directions; a stamp to be attached to the support body; and a biopolymer solution supply unit which supplies plural kinds of biopolymer solutions to be fixed on a surface of the stamp.

In the biochip production apparatus, the biopolymer solution supply unit fixes the biopolymer solutions on the surface of the stamp, and the stamp to which the biopolymer solutions is fixed is pressed against the surface of the substrate.

According to the biochip production apparatus, when the plural kinds of biopolymers are disposed on local places of the stamp, and the stamp is pressed against the biochip substrate. As a result, a plurality of sites in the same arrangement as in the stamp can be formed simultaneously on the substrate. Because the plurality of site's is formed simultaneously, a biochip can be produced in a considerably short time compared with the related art.

In addition, uniform sites can be obtained easily because the stamp is used.

In the biochip production apparatus, a plurality of concaves and convexes are formed on the surface of the stamp. Otherwise, in the biochip production apparatus, the surface of the stamp is made of a porous material and is formed to be flat.

In the biochip production apparatus, the stamp is made of rubber, resin, metal or glass.

In the biochip production apparatus, the stamp includes solution holding portions which hold the biopolymer solutions on periphery or inside of the convex formed on the surface of the stamp. Further, in the biochip production apparatus, the solution holding portions are grooves, cavities or through-holes.

In the biochip production apparatus, the stamp is fixed to the support body by a pneumatic, magnetic or mechanical function.

In the biochip production apparatus, the stamp is attachable to and detachable from the support body. Therefore, different kinds of solutions can be prevented from being contaminated in the stamp.

In the biochip production apparatus, bonding groups which bonds biopolymers in the biopolymer solutions are fixed on the substrate and the stamp fixes the biopolymer solutions on a part of the substrate where the bonding groups are bonded.

In the biochip production apparatus, the stamp is formed integrally from one component or from a combination of components.

In the biochip production apparatus, the stamp is pressed against the surface of the substrate at a plurality of times to transfer the biopolymer solutions onto the substrate.

In the biochip production apparatus, the stamp is disposable. In this case, the contamination of different kinds of solutions biopolymer solutions can be prevented from being contaminated.

The following advantages can be obtained in accordance with the biochip production apparatus.

(1) Because the stamp is disposable, different kinds of solutions can be prevented from being contaminated in the stamp when sites having different kinds of biopolymers arranged thereon are formed.

(2) Because all sites can be stamped simultaneously, a biochip can be produced in a short time.

(3) Because the stamp of rubber or the like is used, the stamp can be pressed against the whole surface of the substrate by uniform force to attain uniformity of sites easily.

### BRIEF DESCRIPTION OF THE DRAWINGS

FIG. 1 is a configuration view showing important part of a biochip production apparatus according to an embodiment of the invention;

FIG. 2 is a view showing another example of a stamp;

FIGS. 3A to 3C are views showing further examples of the stamp;

FIG. 4 is a view showing a further example of the stamp;

FIG. 5 is a view showing another example of a surface of a substrate;

FIG. 6 is a view showing a further example of the front end portion of the stamp;

FIG. 7 is a view showing another example of a solution plate corresponding to the stamp depicted in FIG. 6;

FIGS. 8A and 8B are views showing examples of configuration in the case where bonding groups are used on the substrate;

FIG. 9 is a view showing an example of configuration of the stamp; and

FIG. 10 is a configuration view showing an example of a dispensing device for achieving a biochip producing method as the related art.

### DETAILED DESCRIPTION OF THE PREFERRED EMBODIMENTS

Embodiments of the invention will be described below in detail with reference to the drawings. In the embodiment, after a stamp having a large number of protrusions is brought into contact with a solution plate having a large number of solution reservoirs, biopolymer solutions reserved in the solution reservoirs are fixed on the protrusions of the stamp respectively. The stamp on which the biopolymer solutions are fixed is pressed against a surface of a biochip substrate to transfer the biopolymer solutions onto the surface of the biochip substrate to thereby produce a biochip.

When the biopolymer solutions are injected in the solution reservoirs of the solution plate, the well-known injection means are used to inject the biopolymer solutions in the solution reservoirs (cavities) respectively. The injection means are prepared separately in accordance with the different kinds of biopolymer solutions.

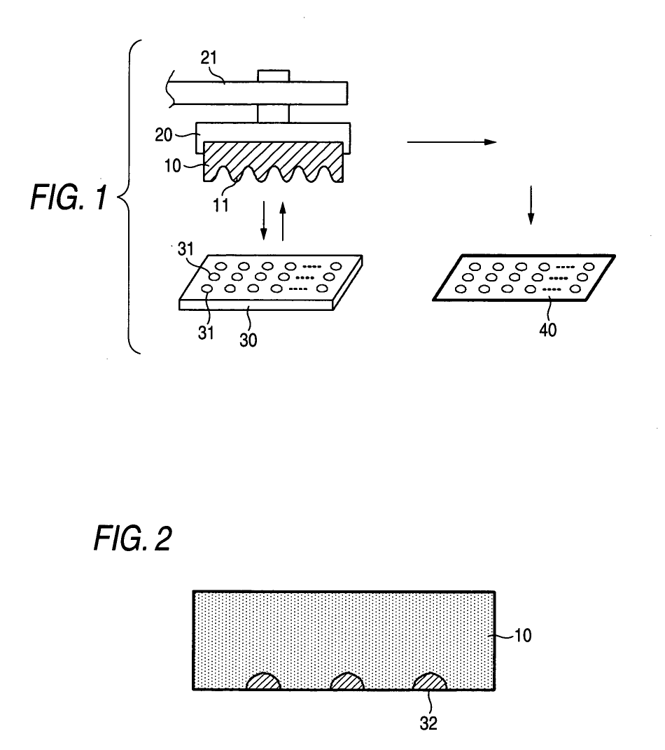

FIG. 1 is a configuration view of important part of a biochip production apparatus according to an embodiment of the invention. In FIG. 1, for example, a stamp 10 is molded of rubber. A plurality of protrusions 11 shaped like peaks are formed as an array in a lower end surface of the stamp. An upper end portion of the stamp 10 is held by a support body 20 detachably.

The support body 20 is linked to an arm 21. The arm 21 is formed so that the arm 21 can be moved up, down, left and right freely by a drive means not shown.

The reference numeral 30 denotes a solution plate. The solution plate 30 has a large number of solution reservoirs 31 formed as cavities in which various kinds of biopolymer solutions can be reserved respectively.

A biochip substrate 40 is provided so that the biopolymer solutions can be fixed on a surface of the substrate by the stamp 10.

In this biochip production apparatus, an operation of producing a biochip will be described below. The solution plate 30 having the solution reservoirs 31 filled with the biopolymer solutions respectively is prepared. The arm 21 is driven to move the stamp 10 to bring the protrusions 11 of the stamp 10 into contact with the solution reservoirs 31, so that the biopolymer solutions are fixed on front ends of the protrusions 11 respectively.

After the biopolymer solutions are fixed, the arm 21 is driven to move the stamp 10 up to a predetermined position and laterally toward the substrate 40 and then move the stamp 10 down to the substrate 40 from just above. The protrusions 11 of the stamp 10 are pressed against the substrate 40 so that the biopolymer solutions fixed on the protrusions 11 are stamped simultaneously on all sites of the substrate 40. After stamping, the stamp 10 is moved up.

Incidentally, the stamp 10 may be pressed against the substrate twice or more to fix the solutions on the substrate.

To produce the same biochips, the aforementioned operation may be repeated to produce the biochips. When the biopolymer solutions are insufficient on the front end portion of the stamp 10, the same solutions may be fed from the solution plate so as to be fixed on the protrusions 11 again. When the solutions are insufficient on the solution plate 30, injection means not shown may be used for supplying respective solutions.

When the stamp deteriorates or when another arrangement of different kinds of biopolymers is to be produced, the old stamp is discarded and exchanged for a new one. The old stamp must not be cleaned to be recycled.

In the biochip production according to this embodiment, different kinds of biopolymer solutions are not contaminated because the stamp is disposable. Moreover, the biochip can be produced in a short time because all sites can be stamped simultaneously. In addition, uniformity of sites can be attained easily because the stamp is made of rubber so that the stamp can be pressed against the substrate by uniform force.

The invention is not limited to the aforementioned embodiment and may include various changes and modifications without departing from the spirit of the invention.

For example, a method of absorbing the stamp 10 by using air or the like, a method of mechanically holding the stamp 10 or a method of absorbing the stamp 10 by a magnet attached to the support body 20 while mixing magnetic particles with the material of the stamp 10 in advance may be used so that the support body 20 can hold the stamp 10.

The stamp 10 is not limited to a stamp made of rubber as in the aforementioned embodiment. Resin, metal or glass available in production of a stamp may be used. The important portions of the stamp 10 may be formed from a porous material. In this case, as shown in FIG. 2, the stamp 10 is impregnated with biopolymer solutions 32 so locally so that the biopolymer solutions 32 are prevented from being contaminated with one another.

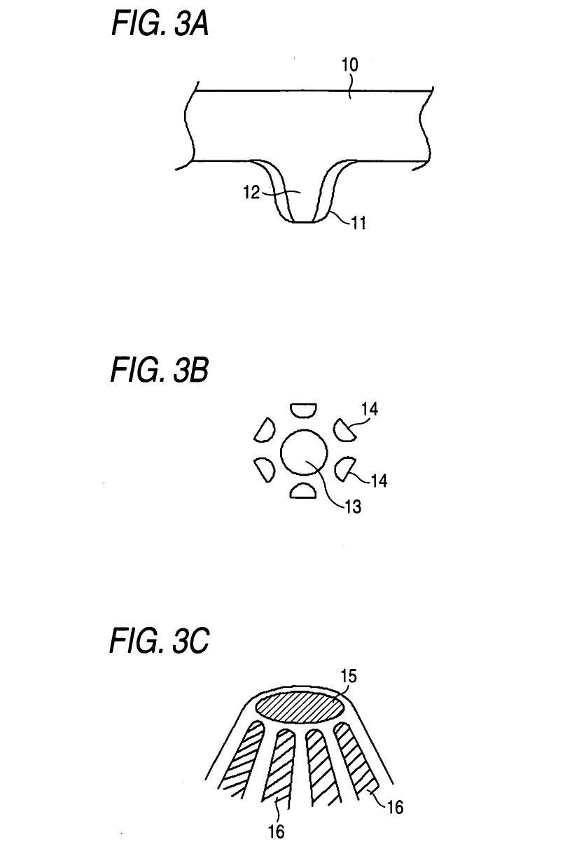

When the stamp 10 is made of resin, metal or glass, grooves, slots, cavities, or the like for reserving the solutions may be formed in the protrusions 11 respectively as shown in FIGS. 3A to 3C.

FIG. 3A shows an example of structure in which a groove 12 is formed in a side surface of each protrusion 11. FIG. 3B shows an example of structure in which a circular cavity 13 is provided in a front end portion of each protrusion 11 and cavities 14 with a diameter smaller than that of the cavity 13 are formed in a peripheral portion of the protrusion 11. Any shape may be used as the shape of each of the cavities 14 in the peripheral portion. For example, each cavity 14 may be semi-circular, elliptic or circular.

FIG. 3C is a structural view showing the case where a circular cavity 15 is provided in a front end portion of each protrusion 11 and grooves 16 or slots are formed in a peripheral portion of the protrusion 11.

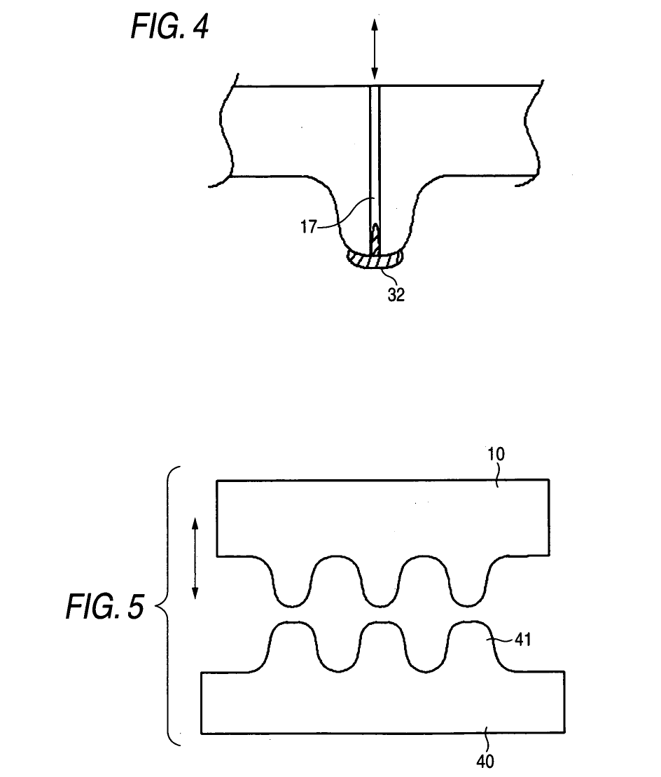

As shown in FIG. 4, a hole 17 passing through the stamp 10 vertically may be formed in the center of each protrusion 11 so that the stamp 10 can be suitably absorbed or pressed from the back by means of air or the like to supply an adequate amount of biopolymer solution 32 to a front end of the protrusion 11.

The surface of the substrate 40 need not be flat as in the embodiment. For example, as shown in FIG. 5, the substrate 40 may have concave and convex portions 41 which are formed in accordance with the concave and convex structure of the protrusions 11 of the stamp 10 so that at least front end portions of the concave and convex portions 41 are flat.

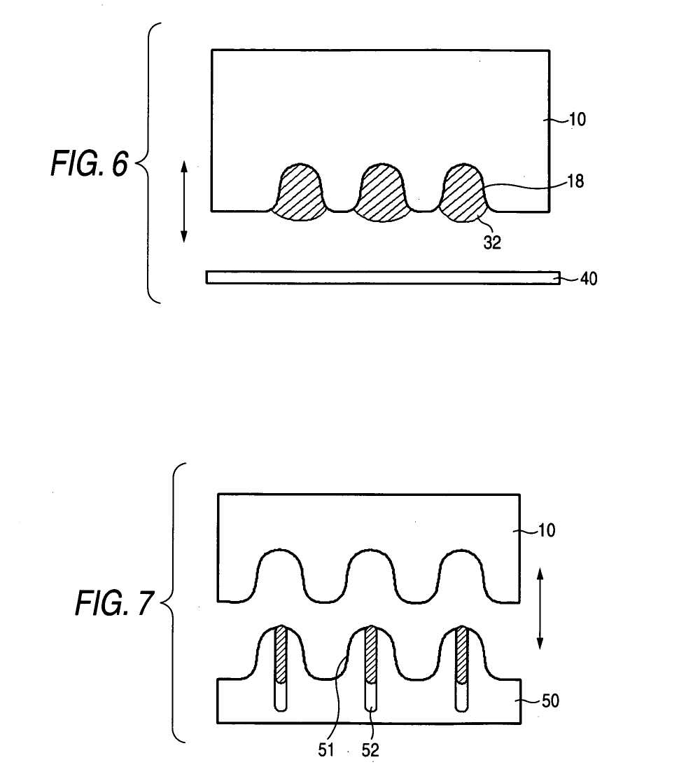

As shown in FIG. 6, cavities 18 may be formed in a surface of the stamp 10 so that biopolymer solutions 32 can be reserved in the cavities 18 respectively. For example, as shown in FIG. 7, a solution plate 50 having protrusions 51 formed complementarily with respect to a surface of the stamp 10 may be used for supplying the biopolymer solutions to the stamp 10. Cavities 52 are provided in the center portions of the protrusions 51 respectively so that capillarity can be used for feeding biopolymer solutions to front end portions of the protrusions 51 along the cavities 52 respectively.

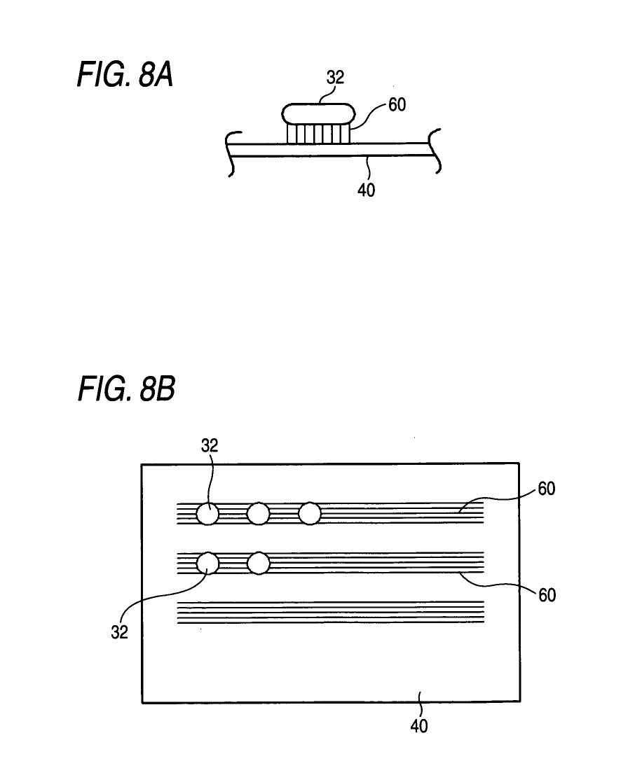

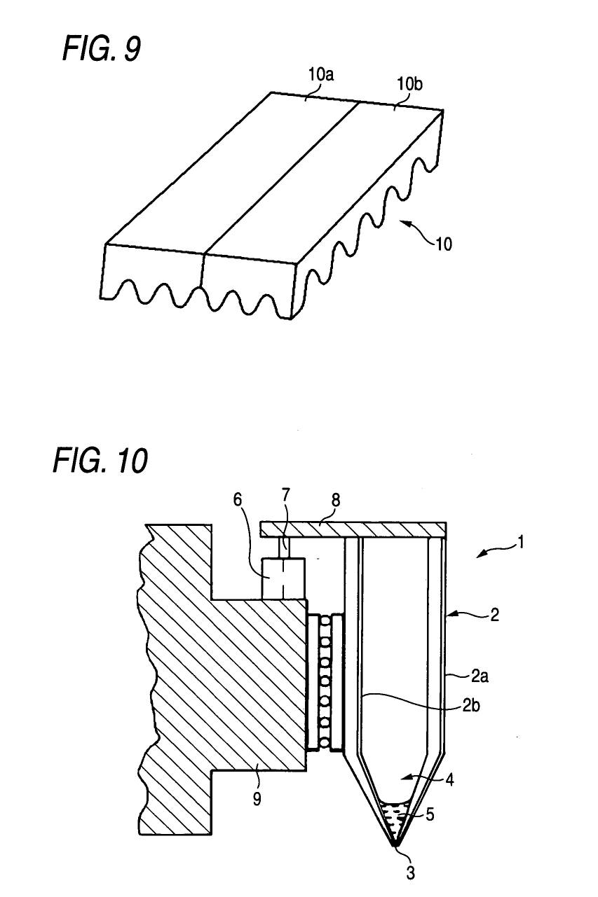

As shown in FIG. 8A which is a side view, circularly shaped bonding groups 60 such as aminosilane may be bonded to a surface of the substrate 40 in advance so that biopolymer solutions 32 can be fixed on the bonding groups 60 respectively by the stamp 10. In this case, it is easy to limit the shape of each site locally.

Incidentally, the shape of each bonding group 60 is not limited to a circular shape. For example, as shown in FIG. 8B which is a plan view, the bonding groups 60 may be linearly shaped.

The stamp need not be formed from one component. For example, as shown in FIG. 9, the stamp may be formed integrally by combining two or more components (e.g. two components 10a and 10b in FIG. 9). In short, any configuration may be used as long as the components can be attached to one another in the form of a unit and discarded.

What is claimed is:

1. A biochip production apparatus for arranging a plurality of different biopolymers on a substrate of a biochip, comprising:
a support body which enables to move in any directions;
a stamp to be attached to the support body; and
a biopolymer solution supply unit which supplies plural kinds of biopolymer solutions to be fixed on a surface of the stamp.

2. The biochip production apparatus according to claim 1,
wherein the biopolymer solution supply unit fixes the biopolymer solutions on the surface of the stamp, and the stamp to which the biopolymer solutions is fixed is pressed against the surface of the substrate:

3. The biochip production apparatus according to claim 1,
wherein a plurality of concaves and convexes are formed on the surface of the stamp,

4. The biochip production apparatus according to claim
wherein the surface of the stamp is made of a porous material and is formed to be flat.

5. The biochip production apparatus according to claim 1,
wherein the stamp is made of rubber, resin, metal or glass.

6. The biochip production apparatus according to claim 1,
wherein the stamp includes solution holding portions which hold the biopolymer solutions on periphery or inside of the convex formed on the surface of the stamp.

7. The biochip production apparatus according to claim 6,
wherein the solution holding portions are grooves, cavities or through-holes.

8. The biochip production apparatus according to claim 1,
wherein the stamp is fixed to the support body by a pneumatic, magnetic or mechanical function.

9. The biochip production apparatus according to claim 1,
wherein the stamp is attachable to and detachable from the support body.

10. The biochip production apparatus according to claim 1,
wherein bonding groups which bonds biopolymers in the biopolymer solutions are fixed on the substrate, and the stamp fixes the biopolymer solutions on a part of the substrate where the bonding groups are bonded.

11. The biochip production apparatus according to claim 1,
is wherein the stamp is formed integrally from one component or from a combination of components.

12. The biochip production apparatus according to claim 2,
wherein the stamp is pressed against the surface of the substrate at a plurality of times to transfer the biopolymer solutions onto the substrate.

13. The biochip production apparatus according to claim 1,
wherein the stamp is disposable.
